(19) United States
(12) Patent Application Publication
(10) Pub. No.: US 2015/0110919 A1
(43) Pub. Date: Apr. 23, 2015

(54) STERILIZED LIQUID PROTEIN SUPPLEMENT INCLUDING A SOLUBILITY ENHANCING NUTRITIONAL PROTEIN

(71) Applicant: ABBOTT LABORATORIES, ABBOTT PARK, IL (US)

(72) Inventors: Paul Johns, Columbus, OH (US); Steven Luebbers, Columbus, OH (US); Kandice Tucker, Columbus, OH (US)

(73) Assignee: ABBOTT LABORATORIES, ABBOTT PARK, IL (US)

(21) Appl. No.: 14/402,614

(22) PCT Filed: May 23, 2013
(86) PCT No.: PCT/US13/42418

§ 371 Date: Nov. 20, 2014

Related U.S. Application Data
(60) Provisional application No. 61/651,078, filed on May 24, 2012.

(51) Int. Cl. A23L 1/29; A23L 1/305

(52) U.S. Cl. CPC A23L 1/296; A23L 1/3053; A23V 2002/00
USPC 426/2; 426/590

(57) ABSTRACT

Disclosed are substantially stable sterilized liquid protein supplements including a highly soluble protein source for use with human milk and other infant or adult feeding formulas. The sterilized liquid protein supplements have a more neutral pH, thereby inhibiting protein denaturation and reducing microbial growth. In one aspect, the sterilized liquid protein supplement comprises at least 250 mg of protein per 1 ml, the protein has a degree of hydrolysis of 25% to 45%, a molecular weight median of less than 800 Daltons, and a dipeptide and tripeptide concentration of no more than 40% by weight total protein, wherein the sterilized liquid protein supplement has a pH of 3 to 8.

### CROSS-REFERENCE TO RELATED APPLICATION

This application claims priority to and any other benefit of U.S. Provisional Patent Application Ser. No. 61/651,078, filed May 24, 2012, and entitled “STERILIZED LIQUID PROTEIN SUPPLEMENT INCLUDING A SOLUBILITY ENHANCING NUTRITIONAL PROTEIN,” the entire disclosure of which is incorporated by reference herein.

### FIELD OF THE DISCLOSURE

The present disclosure relates to a sterilized liquid protein supplement. More particularly, the present disclosure relates to a long term stable, high protein-containing sterilized liquid supplement including at least one protein source having specific solubility enhancing properties. In some embodiments, the protein source is a hydrolyzed whey protein source, and the sterilized liquid protein supplement includes at least 300 milligrams of protein per 1 mL of supplement. The liquid protein supplement is suitable for supplementing human milk or infant formula and for feeding to an infant or preterm infant, or for use as an adult nutritional.

### BACKGROUND OF THE DISCLOSURE

Human milk is generally recognized as an ideal feeding for most infants due to its overall nutritional composition. It is well known and generally accepted that human milk provides infants with unique immunologic and developmental benefits as compared generally to commercially available infant formulas.

For some infants, however, especially preterm infants, human milk does not always meet the complete nutritional needs of the infant. Further many mothers are not able to provide sufficient human milk to their infants. Under these circumstances, infant formulas are commonly used to provide supplemental or sole source nutrition early in life.

Although infants still generally benefit from human milk and/or commercially available infant formulas, it is often desirable to supplement their feedings with additional nutrients. Protein supplements have been previously used to supplement the protein intake of infants, particularly, preterm and low birth weight infants.

Most of the protein supplements described in the literature and commercially available have been formulated as reconstitutable powders rather than liquids in order to minimize the volume displacement of human milk or liquid infant formulas by the supplement. It has recently been found, however, that liquid protein supplements, and specifically highly concentrated liquid protein supplements, are desirable as an alternative to powders as these liquids may have the significant benefit of being easily commercially sterilized as they can be subjected to sufficient heat treatment during manufacturing, including ultra high temperature (UHT) treatment, for sterilization.

To date, however, liquid protein supplements have been typically highly acidic, which can be problematic as the acidity of the supplement can change its natural properties; that is, in some cases, proteins may denature, and this denaturation may potentially impact the nutritional qualities of the supplement. Moreover, many protein supplements are based wholly or in large part on collagen as the protein source. Collagen, however, in some embodiments may be a less desired protein source, and as such, supplements including collagen as a sole protein source are not always desirable for neonate consumption.

Additionally, many liquid protein supplements available to date have had issues with precipitation and sedimentation of the proteinaceous material that occurs over time as the product ages, especially when the protein concentration is greater than about 150 milligrams of protein per mL. In some cases, the undesirable precipitation and sedimentation can begin shortly after manufacture and continue throughout the life of the product. The precipitate and sediment generally have little impact on the nutritional quality of the liquid protein supplement as only a small fraction of the protein actually precipitates out of solution; however, the physical appearance of the precipitate and sediment, which may in some cases be dark colored, may raise concerns about the product viability and/or safety, and may significantly impact commercial desirability. Although this problem may be controlled and minimized to some extent by reducing the protein concentration of the liquid protein supplement, such reduction is commercially undesirable and limits the overall application of the liquid protein supplement as volume displacement concerns may arise.

As such, there is a need for sterilized liquid protein supplements that are sufficiently long term stable and that include high amounts of protein to reduce the amount of water added to human milk or infant formula when the product is utilized. Additionally, it would be very beneficial if the sterilized liquid protein supplements could be made to have a more neutral pH such as to prevent protein denaturation when added to human milk and have the milk remain a more neutral pH.

### SUMMARY OF THE DISCLOSURE

The present disclosure is directed to long term stable sterilized liquid protein supplements for use with preterm infants, infants, pediatrics and adults. The long term stable sterilized liquid protein supplement includes at least one highly soluble, high quality hydrolyzed protein source. Desirably, the protein source is a hydrolyzed whey protein source that is a high quality source of essential amino acids and highly absorbable. The protein source has a degree of hydrolysis of from about 25% to about 45%, a molecular weight median of less than 800 Daltons, and a dipeptide and tripeptide concentration of no more than 40% by weight of the total protein. In many embodiments the long term stable sterilized liquid protein supplement includes at least 300 milligrams of protein per 1 mL of liquid and is highly stable such that precipitation and sedimentation are minimized or eliminated over the shelf life of the product. In some desirable embodiments, the hydrolyzed whey protein source may be used in combination with a hydrolyzed casein source. The liquid protein supplement may also have a pH range of from about 3.0 to about 8.0. Many of the long term stable sterilized liquid protein supplements described herein may be suitably prepared to be fat-free and/or carbohydrate-free, as well as emulsifier-free and/or stabilizer-free. Methods of preparing and using the long term stable sterilized liquid protein supplements described herein are also provided.

The present disclosure is directed to a sterilized liquid protein supplement comprising at least 300 mg of protein per 1 mL. The protein has a degree of hydrolysis of from about 25% to about 45%, a molecular weight median of less than 800 Daltons, and a dipeptide and tripeptide concentration of no more than 40% by weight total protein, wherein the sterilized liquid protein supplement has a pH of from about 3.0 to about 8.0.

The present disclosure is further specifically directed to a sterilized liquid protein supplement comprising at least 300 mg of whey protein per 1 mL. The whey protein has a degree of hydrolysis of from about 25% to about 45%, a molecular weight median of less than 800 Daltons, and a dipeptide and tripeptide concentration of no more than 40% by weight total protein. The sterilized liquid protein supplement has a pH of from about 5.0 to about 7.0.

The present disclosure is further specifically directed to a sterilized liquid protein supplement comprising at least 330 mg of protein per 1 mL and having a pH of from about 3.0 to about 8.0. The protein comprises a whey protein hydrolysate wherein the whey protein hydrolysate, when prepared as a 37.5% by weight solution in water and filtered through a 0.45 μm filter, produces a filtrate having at least 98% by weight protein recovery.

The present disclosure is further specifically directed to a supplemented human milk comprising human milk and a sterilized liquid protein supplement comprising at least 300 mg of protein per 1 mL. The protein has a degree of hydrolysis of from about 25% to about 45%, a molecular weight median of less than 800 Daltons, and a dipeptide and tripeptide concentration of no more than 40% by weight total protein. The sterilized liquid protein supplement has a pH of from about 3.0 to about 8.0.

The present disclosure is further specifically directed to a sterilized liquid protein supplement comprising at least 300 mg of protein per 1 mL and comprising a first protein and a second protein. The first protein is a whey protein hydrolysate having a degree of hydrolysis of from about 25% to about 45%, a molecular weight median of less than 800 Daltons, and a dipeptide and tripeptide concentration of no more than 40% by weight total protein. The second protein is a casein hydrolysate. The sterilized liquid protein supplement has a pH of from about 3.0 to about 8.0.

The present disclosure is further specifically directed to a sterilized liquid protein supplement comprising at least 300 mg of protein per 1 mL. The protein has a degree of hydrolysis of from about 25% to about 45%, a molecular weight median of less than 800 Daltons, and a dipeptide and tripeptide concentration of no more than 40% by weight total protein. The sterilized liquid protein supplement has a pH of from about 3.0 to about 8.0.

It has been unexpectedly found that stable sterilized liquid protein supplements can advantageously be prepared as solutions, including clear solutions, having a high concentration of protein, and in particular, having a high concentration of hydrolyzed protein, when formulated using a protein source with a specific combination of attributes. Specifically, when a protein utilized has a certain degree of hydrolysis, molecular weight median, and dipeptide and tripeptide concentration, a liquid protein supplement can be prepared including at least 300 milligrams of protein per 1 mL of liquid protein supplement and, in some embodiments, up to 333 milligrams of protein per 1 mL liquid. By utilizing the highly soluble protein as described herein, the liquid protein supplements can be sufficiently concentrated so as to not unacceptably dilute the other components of human milk or other infant formulas and be sufficiently shelf stable.

Additionally, by using the highly soluble protein as defined herein in the liquid protein supplement, the solubility of critical amino acids, including the solubility of L-tyrosine, can be significantly improved further improving the overall nutritional value of the product. Also, because the protein as defined herein is highly soluble and stable, the shelf life and overall stability of the liquid protein supplement is significantly improved such that the product is stable and highly resistant to precipitation/sedimentation/crystallization for long periods of time.

Additionally, the more neutral pH levels of the sterilized liquid protein supplements described herein may prevent denaturation of the proteins in human milk or other infant formulas to be supplemented with the liquid protein supplement, thereby allowing for sufficient protein supplementation to infants, particularly preterm and low birth weight infants. Further, the pH levels allow the sterilized liquid protein supplements to be added to human milk without the need for adjusting the pH of the final liquid product.

### DETAILED DESCRIPTION OF THE DISCLOSURE

The present disclosure is generally directed to sterilized liquid protein supplements, methods of preparing the sterilized liquid protein supplements, and methods of using the sterilized liquid protein supplements. The sterilized liquid protein supplements of the present disclosure generally comprise a protein source, and in particular a hydrolyzed protein source, that is highly soluble in water such that a long term stable liquid protein supplement including, in many embodiments, at least 300 milligrams of protein per mL of supplement can be produced. The protein source utilized has a specifically defined degree of hydrolysis, molecular weight median, and dipeptide and tripeptide concentration that has been discovered to provide a highly soluble protein. In some embodiments, the sterilized liquid protein supplements are substantially clear liquid protein supplements being substantially free of carbohydrate and fat and may also be substantially free of emulsifiers and/or stabilizers. In addition to providing for a more stable liquid high protein supplement with a reduced amount of precipitation and sedimentation the protein source provides a high quality source of amino acids and is highly absorbable. In many embodiments the hydrolyzed protein source is a hydrolyzed whey protein source.

The sterilized long term stable liquid protein supplements described herein provide for an improved, easy to use high protein nutritional supplement that is sterile, long term stable, and easily mixable with human breast milk and/or infant formula to improve the nutritional quality of the resulting liquid with minimum volume displacement. These protein-dense supplements provide the commercial advantage of a sterile liquid as compared to conventional powder forms and have, through the use of a specifically defined protein source, overcome traditional hurdles related to the formation of precipitation, sedimentation, and off-color over time typically associated with high protein liquids. In some embodiments, the sterile liquid protein supplements may further include additional components including vitamins, minerals, and the like.

In addition, the specified protein sources described herein, and specifically the specified whey protein hydrolysates, may be a biologically active addition to adult nutritional products and adult nutritional supplements, including diabetic adult nutritional products and supplements and muscle health adult nutritional products and supplements.

These and other optional elements or limitations of the sterilized liquid protein supplements and methods of the present disclosure are described in detail hereinafter.

The terms “substantially clear liquid” or “substantially clear sterilized liquid protein supplement” as used herein, unless otherwise specified, are used interchangeably and refer to non-emulsified or similar other liquids having a visibly clear or translucent appearance, which liquid may and typically will have a thin or watery texture with a consistency similar to that of a clear juice and most typically having a viscosity of less than 25 centipoises as determined by a Brookfield viscometer at 22° C. using a #1 spindle at 60 rpm.

The terms “sterile”, “sterilized” and “sterilization” as used herein, unless otherwise specified, refer to the reduction in transmissible agents such as fungi, bacteria, viruses, spore forms, and so forth, in food or on food grade surfaces to the extent necessary to render such foods suitable for human consumption. Sterilization processes may include various techniques involving the application of heat, peroxide or other chemicals, irradiation, high pressure, filtration, or combinations or variations thereof.

The term “retort packaging” and “retort sterilizing” are used interchangeably herein, and unless otherwise specified, refer to the common practice of filling a container, most typically a metal can or other similar package, with a liquid protein supplement and then subjecting the liquid-filled package to the necessary heat sterilization step, to form a sterilized, retort packaged, liquid protein supplement.

The term “total solids”, unless otherwise specified herein refers to all material components of the compositions of the present disclosure, less water.

The term “hypoallergenic” as used herein means that the sterilized liquid protein supplement has a decreased tendency to provoke an allergic reaction in a user, such as a preterm or term infant, as compared to non-hypoallergenic liquid supplements. More particularly, the sterilized liquid protein supplement is hypoallergenic when there is 95% confidence that 90% of allergic infants would not react to the supplement in a double-blind, placebo-controlled (DBPC) study. An example of a suitable DBPC study is described in Kleinman, et al. “Use of infant formulas in infants with cow milk allergy: a review and recommendations,” Pediatr Allergy Immunol 1991, 4: 146-155.

The term “stable” as used herein means that the sterilized liquid protein supplement is resistant to separation and precipitation for a time period after manufacture of at least three months, and desirably at least six months and desirably at least one year.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the sterilized liquid protein supplements of the present disclosure may also be substantially free of any optional or selected ingredient or feature described herein, provided that the remaining sterilized liquid protein supplement still contains all of the required ingredients or features as described herein. In this context, and unless otherwise specified, the term “substantially free” means that the selected sterilized liquid protein supplement contains less than a functional amount of the optional ingredient, typically less than 5% by weight, including less than 4% by weight, including less than 3% by weight, including less than 2% by weight, including less than 1% by weight, including less than 0.5% by weight, including less than 0.1% by weight, and also including zero percent by weight of such optional or selected ingredient.

The sterilized liquid protein supplements and corresponding manufacturing methods of the present disclosure can comprise, consist of, or consist essentially of the essential elements and limitations of the disclosure as described herein, as well as any additional or optional ingredients, components, or limitations described herein or otherwise useful in the sterilized liquid protein supplement.

### Product Form

The sterilized liquid protein supplements of the present disclosure including the highly soluble protein source may be used as a supplemental source of nutrition and may optionally be in the form of clear or substantially clear liquids. The sterilized liquid protein supplements are suitable for use as human milk fortifiers, infant liquid nutritionals, and/or preterm liquid nutritionals, as well as adult nutritionals and adult supplements. When used as adult nutritionals and/or adult supplements, the sterilized liquid protein supplements will generally include at least one, or two, or three or more additional protein sources, and may also include at least one of fat and carbohydrate.

The sterilized liquid protein supplements of the present disclosure are generally thin liquids comprising a highly soluble protein source as described below. The sterilized liquid protein supplements may be, in some embodiments, substantially fat free and substantially carbohydrate free; that is, the supplements are devoid of added fat and carbohydrate except for that fat and carbohydrate inherent to the raw materials or added fat or carbohydrate at low concentrations to aid in the manufacture of the sterilized liquid protein supplement. In this context, the term “fat free” and/or “carbohydrate free” means that the sterilized liquid protein supplement typically contains less than 1.0%, more typically less than 0.5%, and more typically less than 0.1%, including zero percent, fat and/or carbohydrate by weight of the sterilized liquid protein supplement. Additionally as noted above, in some embodiments the sterilized liquid protein supplements may be emulsifier-free and/or stabilizer-free.

The sterilized liquid protein supplements of the present disclosure have a solids content of at least 10%, including from 10% to about 50%, further including from 10% to about 40%, and further including from about 15% to about 35%. The sterilized liquid protein supplements are liquids that are capable of being poured directly from a package containing them into human milk, other infant feeding formula, or a combination thereof, to produce a liquid suitable for feeding to infants, including preterm infants.

To provide improved stability and shelf-life, it is generally desirable that the sterilized liquid protein supplements of the present disclosure include insoluble solids at a concentration of less than 5 grams per 100 grams of the sterilized liquid protein supplement, including an insoluble solids content of from about 0.5 grams to less than 5 grams per 100 grams of the sterilized liquid protein supplement, or even an insoluble solids concentration of 0 grams per 100 grams of the sterilized liquid protein supplement. Having a low insoluble solids content may result in less precipitation of the solids out of solution (i.e., plugging/fouling) and an improved appearance of the sterilized liquid protein supplements which, as noted above, may be clear or substantially clear in some embodiments.

The sterilized liquid protein supplements may be and typically are shelf-stable. The sterilized liquid protein supplements typically contain up to 95% by weight of water, including from about 50% to 95%, also including from about 60% to about 90%, and also including from about 70% to about 85%, of water by weight of the sterilized liquid protein supplement.

The sterilized liquid protein supplements may have a variety of product densities, but most typically have a density greater than 1.040 g/mL, including from about 1.06 g/mL to about 1.12 g/mL, and also including from about 1.085 g/mL to about 1.10 g/mL.

The sterilized liquid protein supplements are generally formulated to have a caloric density of at least 0.4 kcal/mL, including at least 0.8 kcal/mL, including from 0.4 kcal/mL to about 1.2 kcal/mL, including from about 0.6 kcal/mL to about 1.1 kcal/mL, and including from about 0.8 kcal/mL to about 0.94 kcal/mL.

The sterilized liquid protein supplements are further formulated to have a pH sufficient to reduce or inhibit microbial growth, particularly growth of C. sakazakii, Clostridium botulinum, Salmonella spp., Staphylococcus aureus, and Escherichia coli, as well as many food spoilage microorganisms known in the art. Preferably, the sterilized liquid protein supplements are prepared to have a pH ranging from about 3.0 to about 8.0, but are most advantageously in a pH range of from about 5.0 to about 7.0, and including from about 5.5 to about 6.5.

### Macronutrients

The sterilized liquid protein supplements of the present disclosure include a highly soluble protein component as described herein. The sterilized liquid protein supplements may include macronutrients of sufficient types and amounts that, when used in combination with human milk or other infant feeding formula, help meet the nutritional needs of the user, especially the premature infant.

### Protein Source

The sterilized liquid protein supplements of the present disclosure include a highly soluble protein source that is a high quality source of essential amino acids and highly absorbable. In some embodiments, the highly soluble protein source may be a protein hydrolysate, including a whey protein hydrolysate. These highly soluble protein sources enable the preparation of stabilized liquid protein supplements that can increase the delivery of nutrients and amino acids, and L-tyrosine specifically. In some embodiments of the present disclosure, the aqueous solubility of L-tyrosine may be 2.6 times greater with the highly soluble protein as described herein as compared to L-tyrosine in water only.

The highly soluble protein source has a narrowly specified degree of hydrolysis that, in combination with the other protein attributes described herein, impacts the overall solubility of the protein. The degree of hydrolysis is the extent to which peptide bonds are broken by a hydrolysis method. The degree of protein hydrolysis for purposes of characterizing a hydrolyzed protein component of some embodiments described herein is easily determined by one of ordinary skill in the formulation arts by quantifying the amino nitrogen to total nitrogen ratio (AN/TN) of the protein component of the selected formulation. The amino nitrogen component is quantified by a USP titration method or by a published colorimetric method (e.g., TNBS or OPA colorimetry) for determining amino nitrogen content, while the total nitrogen component is determined by the Tecator Kjeldahl method, all of which are well known methods to one of ordinary skill in the analytical chemistry art.

The degree of hydrolysis of the highly soluble protein source is from about 25% to about 45%, including from about 25% to about 40%, including from about 25% to about 38%, including from about 27% to about 38%, including from about 29% to about 37%, including from about 30% to about 35%, including from about 30% to about 34%, and including about 32%. In some embodiments, the degree of hydrolysis may be 20%, or even 25%, or even 27%, or even 29%, or even 30%, or even 31% or even 32%.

In addition to the specified degree of hydrolysis, the highly soluble protein source has a specified molecular weight median to enhance the solubility of the protein source in the sterilized liquid protein supplement. The molecular weight median of the highly soluble protein is less than 800 Daltons, including less than 750 Daltons, including less than 725 Daltons, including less than 700 Daltons, including less than 675 Daltons, including less than 650 Daltons, including less than 625 Daltons, including less than 600 Daltons, including less than 575 Daltons, including less than 570 Daltons, including less than 565 Daltons, including less than 560 Daltons, including about 550 Daltons. In some embodiments, the molecular weight median of the highly soluble protein is from about 550 Daltons to about 800 Daltons, including from about 550 Daltons to about 700 Daltons, including from about 550 Daltons to about 650 Daltons, and including from about 550 Daltons to about 600 Daltons.

In addition to the specified degree of hydrolysis and specified molecular weight median, the highly soluble protein source has a specified dipeptide and tripeptide concentration to enhance the solubility of the protein source in the sterilized liquid protein supplement. The dipeptide and tripeptide concentration of the highly soluble protein source is no more than 40% by weight total protein, including no more than 35% by weight total protein, including no more than 32% by weight total protein, including no more than 30% by weight total protein, including no more than 28% by weight total protein, including no more than 27% by weight total protein, including about 26% by weight total protein. In some embodiments, the degree of hydrolysis is from about 26% to about 40%, including from about 26% to about 35%, including from about 26% to about 30%, and including from about 26% to about 28%.

The sterilized liquid protein supplements of the present disclosure include much higher concentrations of protein as compared to conventional liquid protein supplements as noted herein as the highly soluble proteins allow for increased protein concentrations that remain stable over long periods of time. The sterilized liquid protein supplement in accordance with the present disclosure includes at least 300 mg protein per mL, including at least 310 mg protein per mL, including at least 315 mg protein per mL, including at least 320 mg protein per mL, including at least 325 mg protein per mL, including at least 330 mg protein per mL, and including about 333 mg protein per mL. In some embodiments, the sterilized liquid protein supplements include at least 200 mg protein per mL, including at least 220 mg protein per mL, including at least 240 mg protein per mL, including at least 250 mg protein per mL, including at least 275 mg protein per mL, and including at least 295 mg protein per mL. In other embodiments, the sterilized liquid protein supplements include from about 200 to about 330 mg protein per mL, including from about 225 to about 330 mg protein per mL, including from about 250 to about 330 mg protein per mL, and including from about 275 to about 330 mg protein per mL. This protein may come from one, two, three or more sources.

In one embodiment of the present disclosure, highly soluble proteins suitable for use in the sterilized liquid protein supplements of the present disclosure may be identified by utilizing a protein recovery test using a suitably sized filter, such as a suitably sized PTFE filter. In this embodiment, a protein containing aqueous solution is first prepared by introducing 37.5 g of a protein source into 62.5 g of room temperature water (to give a total of 100.0 g, so that the concentration of the protein source is 37.5% by weight) and stirring the protein in water solution for thirty minutes at room temperature. An aliquot of this stirred protein containing aqueous solution is then syringe-filtered through a 0.45 micron membrane and the filtrate is tested for protein concentration (e.g., by high performance liquid chromatography or by some other suitable quantitative analytical technique). A protein suitable for use in the liquid protein supplements of the present disclosure will have at least 98% by weight of the total protein in the filtrate and have a visible light transmittance, as measured at 860 nm vs. purified water, of at least 99%. Proteins or protein sources that meet these requirements are highly soluble proteins as discussed herein and may suitably be used in the sterilized liquid protein supplements of the present disclosure.

One particularly suitable protein hydrolysate source for use in the liquid protein supplements of the present disclosure is Tatua W4015 whey protein hydrolysate (Morrinsville, New Zealand), which is approximately 80% protein by weight and has a degree of hydrolysis of about 32%, a molecular weight median of about 550 Daltons, and a dipeptide and tripeptide concentration of about 26% by weight total protein. This particularly suitable protein source can be the sole protein source in the sterilized liquid protein supplement, or may be used in combination with one or more other protein sources.

As noted above, it has been unexpectedly found that the free L-tyrosine solubility in water is substantially increased in accordance with the present disclosure; that is, it has been found that a 2.6 fold enhancement of the solubility of free L-tyrosine occurs in a 37.5% (w/w) aqueous solution of Tatua W4015 whey protein hydrolysate as compared to the solubility of free L-tyrosine in water (Tatua W4015 whey protein concentrate has a free L-tyrosine concentration of 1300 mg/L, which is 2.6 times than the aqueous solubility of free L-tyrosine of 500 mg/L.)

In addition to the highly soluble protein source as described herein, the sterilized liquid protein supplement may, in some embodiments, include an additional protein source. The additional protein source may include any number of hydrolyzed, including extensively hydrolyzed, and/or intact protein or elemental ingredients. Suitable examples of hydrolyzed or non-hydrolyzed (intact) proteins can be derived from any known or otherwise suitable source such as milk (e.g., casein, whey, lactose-free milk protein isolates), animal (e.g., meat, fish), cereal (e.g., rice, corn), vegetable (e.g., soy, pea, bean), or combinations thereof. One particularly suitable additional protein source is a casein hydrolysate, such as Dellac CE90HM casein hydrolysate (Friesland Campina, Deltown Specialties Division, Delhi N.Y.)

### Vitamins and Minerals

The sterilized liquid protein supplements of the present disclosure may further comprise any of a variety of vitamins, non-limiting examples of which include vitamin A, vitamin D, vitamin E, vitamin K, thiamine, riboflavin, pyridoxine, vitamin B₁₂, niacin, folic acid, pantothenic acid, biotin, vitamin C, choline, inositol, salts and derivatives thereof, and combinations thereof. In some desirable embodiments, the sterilized liquid protein supplements further include water soluble vitamins such as vitamin B₁₂, niacin, folic acid, biotin, pantothenic acid, and vitamin C.

The sterilized liquid protein supplements may also further comprise any of a variety of minerals known or otherwise suitable for use in infant or other nutritional formulas, non-limiting examples of which include phosphorus, magnesium, calcium, zinc, manganese, copper, iodine, sodium, potassium, chloride, selenium, and combinations thereof.

### Other Optional Ingredients

The sterilized liquid protein supplements of the present disclosure may further optionally comprise other ingredients that may modify the physical, chemical, aesthetic or processing characteristics of the compositions or serve as pharmaceutical or additional nutritional components when used in the targeted population. Many such optional ingredients are known for use in food and nutritional products, including infant formulas, and may also be used in the sterilized liquid protein supplements of the present disclosure, provided that such optional materials are compatible with the materials described herein, are safe and effective for their intended use, and do not otherwise unduly impair product performance.

Non-limiting examples of such optional ingredients include preservatives, anti-oxidants, various pharmaceuticals, buffers, carotenoids, colorants, flavors, nucleotides and nucleosides, thickening agents, prebiotics, probiotics, sialic acid-containing materials, and other excipients or processing aids.

### Method of Manufacturing

The sterilized liquid protein supplements of the present disclosure may generally be prepared using the following method: suspending a highly soluble protein source in an aqueous solution using agitation to form a protein component suspension or solution mixture having a protein component concentration greater than 30% by weight; diluting the suspension or solution mixture with water to form a diluted mixture having a protein component concentration of from about 25% to about 30% by weight; heating the diluted mixture with agitation; cooling the heated mixture; homogenizing the cooled mixture and holding the homogenized mixture at a cooled temperature for a period; further cooling the homogenized mixture; and diluting the cooled homogenized mixture with water to form a cooled homogenized mixture comprising more than 10 grams per 100 mL protein component. The homogenized mixture may then be filled into a suitable bottle or container and sterilized.

In one or more other desirable embodiments, the sterilized liquid protein supplement is prepared by first suspending a highly soluble protein source in an aqueous solution using agitation to form a protein suspension mixture having a protein concentration of greater than 30% by weight, including from about 35% to about 65% by weight, including from about 35% to about 57% by weight, and including from about 45% to about 50% by weight. All or at least a portion of the protein source may be a highly soluble whey protein hydrolysate. In one embodiment, the protein source is solely a whey protein hydrolysate and is suspended in water at a temperature of from about 120° F. to about 180° F. to make the protein suspension mixture. The whey protein hydrolysate is added with sufficient agitation to disperse the protein and keep insoluble amino acids/peptides in suspension. While maintaining both the temperature and agitation, additional water is then added to further dilute the suspension mixture to a protein concentration of from about 25% to about 40% by weight, including about 37.5% by weight.

The diluted protein suspension mixture is then heated with agitation to a temperature of from about 150° F. to about 210° F., including from about 165° F. to about 175° F. and treated at from 0 to about 500 psig, including from 0 to about 300 psig.

The treated mixture is then again heated using a two-step heating process. In a first heating step, the treated mixture is heated using, for example, an ultra high temperature (UHT) treatment to a temperature of from about 240° F. to about 260° F., including from about 248° F. to about 252° F. A second heating step is then conducted using steam injection UHT to heat the mixture to a temperature of from about 275° F. to about 305° F., including from about 300° F. to about 302° F. The mixture is held at this second heat temperature for a period of about from about 1 second to about 5 seconds.

The heated mixture can then be cooled to a temperature of from about 150° F. to about 200° F. In some embodiments, the cooling step is a two-step/stepwise cooling process to prevent precipitation of solids in the mixture. For example, the heated mixture can first be cooled to a temperature of from about 225° F. to about 265° F., including from about 248° F. to about 252° F., and then the mixture can further be cooled to a temperature of from about 150° F. to about 200° F., including from about 160° F. to about 170° F. to remove steam and water. Any known method of cooling can be used to cool the heated mixture. One suitable method includes flash cooling.

The cooled mixture is then homogenized at from 0 to about 500 psig, including from 0 to about 300 psig and held at a temperature of from about 150° F. to about 200° F. for a period of from about 10 seconds to about 20 seconds.

The homogenized mixture is then cooled to a temperature of less than 100° F., desirably a temperature of from about 30° F. to about 45° F., including from about 34° F. to about 45° F. Finally, the cooled homogenized mixture is diluted with water to form a sterilized liquid protein supplement having a target protein component content, such as a protein component content of more than 10 grams per 100 mL of final sterilized liquid protein supplement, including more than 12 grams per 100 mL of sterilized liquid protein supplement, and including more than 14 grams per 100 mL of sterilized liquid protein supplement. In some embodiments, the protein component concentration may be from about 14 grams to about 33 grams per 100 mL of sterilized liquid protein supplement, including from about 18 grams to about 33 grams per 100 mL of sterilized liquid protein supplement, including from about 20 grams to about 33 grams per 100 mL of sterilized liquid protein supplement, including from about 25 grams to about 33 grams per 100 mL of sterilized liquid protein supplement, including from about 28 grams to about 33 grams per 100 mL of sterilized liquid protein supplement, and including from about 30 grams to about 33 grams per 100 mL of sterilized liquid protein supplement. In one desirable embodiment, the protein component concentration may be from about 30 grams to about 33 grams of protein per 100 mL of final sterilized liquid protein supplement.

Once diluted to its final protein component concentration, the liquid protein is commercially sterilized for long term shelf stability, commonly by either retort or aseptic processing/packaging. The retort packaging can be accomplished using any of a variety of techniques well known to those of ordinary skill in the art, so long as the heat treatment is sufficient (i.e., about 125° C. for about 20-30 minutes) to achieve long term shelf stability of the sterilized liquid protein supplement. Alternatively, the aseptic processing/packaging can be accomplished by using any of a variety of techniques well known to those skilled in the art so long as the heat treatment (i.e., about 145° C. for 5 seconds) and packaging conditions are sufficient to achieve and maintain commercial sterility.

### Method of Use

The sterilized liquid protein supplement of the present disclosure may be used in combination with human milk or other suitable infant formula, or a combination of both, wherein the resulting fortified human milk or fortified infant formula or combination of both has an osmolality suitable for oral administration to an infant, including a preterm infant. The osmolality of human milk is generally about 286 mOsm/kg water; the osmolality of the combination of sterilized liquid protein supplement and human milk (or infant formula) will most typically be less than 500 mOsm/kg water, more typically from about 300 mOsm/kg water to about 400 mOsm/kg water. In some embodiments, the osmolality of the combination of sterilized liquid protein supplement and human milk is from about 285 mOsm/kg water to about 315 mOsm/kg water, and desirably about 298 mOsm/kg water.

The sterilized liquid protein supplements of the present disclosure may be added directly to human milk or infant formula or both in a volume to volume ratio of from about 1 mL sterilized liquid protein supplement to 100 mL of human milk or formula to about 5 mL sterilized liquid protein supplement to 100 mL of human milk or formula, and including about 3 mL sterilized liquid protein supplement to 100 mL of human milk or formula. The ratio is ultimately selected based primarily upon the ingredients and concentration of the sterilized liquid protein supplement and in view of the particular nutritional needs of the infant. The sterilized liquid protein supplements may be added directly to every feeding or to a sufficient number of feedings (e.g., once or twice daily) to provide optimal nutrition in view of the particular nutritional needs of the infant.

Human milk or other infant feeding formula, after fortification with the sterilized liquid protein supplement, will most typically have a caloric density ranging from about 11 kcal/fl oz (0.4 kcal/mL) to about 35 kcal/fl oz (1.2 kcal/mL), including from about 19 kcal/fl oz (0.64 kcal/mL) to about 30.0 kcal/fl oz (1.0 kcal/mL) with the 22-26.7 kcal/fl oz formulations (0.74-0.90 kcal/mL) being more useful in preterm infants, and the 19-21 kcal/fl oz (0.64-0.71 kcal/mL) formulations more useful for term infants.

The methods of the present disclosure therefore include a method of providing nutrition to infants, especially preterm infants, said method comprising the addition of the liquid protein supplement to human milk or other infant feeding formula, followed by the administration of the fortified human milk or feeding formula to the infant.

### EXAMPLES

The following examples illustrate specific embodiments and/or features of the sterilized liquid protein supplements of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the formulation, unless otherwise specified.

### Example 1

In this Example, a sterilized liquid protein supplement including a single protein component of a whey protein hydrolysate is prepared using the methods of the present disclosure. The whey protein hydrolysate is Tatua W4015 whey protein hydrolysate.

Specifically, the whey protein hydrolysate is suspended in water at a temperature of from about 120° F. to about 180° F. to make a protein suspension mixture having a protein component concentration of about 47.5% by weight. The whey protein hydrolysate is added with sufficient agitation to disperse the protein and keep insoluble amino acids/peptides in suspension. While maintaining both the temperature and agitation, additional water is then added to further dilute the protein suspension mixture to a protein concentration of about 37.5% by weight. The diluted mixture is then heated to a temperature of from about 165° F. to about 175° F. and is treated at from 0 to about 300 psig. The treated mixture is then again heated using a two-step heating process. In the first heating step, the treated mixture is heated using an ultra high temperature (UHT) treatment to a temperature of from about 248° F. to about 252° F. A second heating step is then conducted using steam injection UHT to heat the mixture to a temperature of from about 300° F. to about 302° F. The treated mixture is held at this temperature for a period of about 5 seconds.

The heated mixture is then flash cooled to a temperature of from about 248° F. to about 252° F. to remove steam and water. The mixture is then further cooled to a temperature of from about 160° F. to about 170° F. The cooled mixture is then homogenized at from 0 to about 300 psig and held at a temperature of from about 165° F. to about 185° F. for a period of about 16 seconds.

The homogenized mixture is then cooled to a temperature of from about 34° F. to about 45° F. Finally, the cooled homogenized mixture is diluted with water to form a liquid protein supplement having a target protein component content of about 33.3 grams hydrolyzed whey per 100 mL liquid protein supplement.

The sterilized liquid protein supplement is then filled into a container and retort sterilized to produce the final product.

### Example 2

In this Example, several exemplary sterilized liquid protein supplements of the present disclosure are set forth.

Table 1 shows a sterilized liquid protein supplement produced according the disclosure set forth herein including 333 mg protein per mL. Table 2 shows a sterilized liquid protein supplement produced according to the disclosure set forth herein including 250 mg protein per mL. Table 3 shows a sterilized liquid protein supplement produced according to the disclosure set forth herein including 200 mg protein per mL. Table 4 shows a sterilized liquid protein supplement produced according to the disclosure set forth herein including 167 mg protein per mL. Table 5 shows a sterilized liquid protein supplement produced according to the disclosure set forth herein including 250 mg protein per mL, wherein the protein is a 70%/30% whey/casein mixture, which mimics human milk. Table 6 shows a protein system suitable for use in an adult nutritional liquid directed at muscle health.

TABLE 1

| | Concentration, |
|---|---|
| Ingredient | Kg per 1000 Kg |
| Water | 625 |
| Tatua W4015 Whey Protein Hydrolysate | 375 |
| Total | 1000 |

TABLE 2

| | Concentration, |
|---|---|
| Ingredient | Kg per 1000 Kg |
| Water | 718 |
| Tatua W4015 Whey Protein Hydrolysate | 282 |
| Total | 1000 |

TABLE 3

| | Concentration, |
|---|---|
| Ingredient | Kg per 1000 Kg |
| Water | 775 |
| Tatua W4015 Whey Protein Hydrolysate | 225 |
| Total | 1000 |

TABLE 4

| | Concentration, |
|---|---|
| Ingredient | Kg per 1000 Kg |
| Water | 812 |
| Tatua, W4015 Whey Protein Hydrolysate | 188 |
| Total | 1000 |

TABLE 5

| | Concentration, |
|---|---|
| Ingredient | Kg per 1000 Kg |
| Water | 732 |
| Tatua W4015 Whey Protein Hydrolysate | 197 |
| Dellac CE90HM Casein Protein | 71 |
| Hydrolysate | |
| Total | 1000 |

TABLE 6

| | Grams of Protein Per |
|---|---|
| Protein Ingredient | Liter of Nutritional |
| Milk Protein Concentrate | 22 |
| Sodium Caseinate | 22 |
| Soy Protein Isolate | 8 |
| Tatua W4015 Whey Protein Hydrolysate | 3 |

1. A sterilized liquid protein supplement comprising at least 300 mg of protein per 1 mL, the protein having a degree of hydrolysis of 25% to 45%, a molecular weight median of less than 800 Daltons, and a dipeptide and tripeptide concentration of no more than 40% by weight total protein, wherein the sterilized liquid protein supplement has a pH of from 3 to 8.

2. The sterilized liquid protein supplement according to claim 1 wherein the protein is a whey protein hydrolysate.

3. The sterilized liquid protein supplement according to claim 1 wherein the sterilized liquid protein supplement comprises at least 320 mg of protein per 1 mL and the protein has a degree of hydrolysis of 25% to 40%, a molecular weight median of less than 700 Daltons, and a dipeptide and tripeptide concentration of no more than 35% by weight total protein.

4. The sterilized liquid protein supplement according to claim 1, wherein the sterilized liquid protein supplement comprises at least 330 mg of protein per 1 mL and the protein has a degree of hydrolysis of 30% to 35%, a molecular weight median of less than 600 Daltons, and a dipeptide and tripeptide concentration of no more than 30% by weight total protein.

5. The sterilized liquid protein supplement according to claim 1, wherein the sterilized liquid protein supplement comprises at least 330 mg of protein per 1 mL and the protein has a degree of hydrolysis of from about 30% to about 35%, a molecular weight median of less than 575 Daltons, and a dipeptide and tripeptide concentration of no more than 28% by weight total protein.

6. The sterilized liquid protein supplement according to claim 1, wherein the sterilized liquid protein supplement comprises about 333 mg of protein per 1 mL and the protein has a degree of hydrolysis of about 32%, a molecular weight median of about 550 Daltons, and a dipeptide and tripeptide concentration of about 26% by weight total protein.

7. The sterilized liquid protein supplement according to claim 1, wherein the sterilized liquid protein supplement is substantially free of fat and carbohydrate.

8. The sterilized liquid protein supplement according to claim 1, wherein the sterilized liquid protein supplement has a pH of 5 to 7.

9. The sterilized liquid protein supplement according to claim 1, wherein the supplement comprises at least 330 mg of protein per 1 mL, has a pH of 3 to 8, the protein comprises a whey protein hydrolysate, and the whey protein hydrolysate, when prepared as a 37.5% by weight solution in water and filtered through a 0.45 μm filter, produces a filtrate having at least 98% by weight protein recovery.

10. The sterilized liquid protein supplement according to claim 2, wherein the protein further comprises casein hydrolysate.

11. A sterilized liquid protein supplement comprising at least 250 mg of protein per 1 mL, the protein having a degree of hydrolysis of 25% to 45%, a molecular weight median of less than 800 Daltons, and a dipeptide and tripeptide concentration of no more than 40% by weight total protein, wherein the sterilized liquid protein supplement has a pH of 3 to 8.

12. The sterilized liquid protein supplement according to claim 11, wherein the supplement is clear or substantially clear.

13. The sterilized liquid protein supplement according to claim 11, in combination with human milk.

14. A method of providing nutrition to an infant comprising the addition of the sterilized liquid protein supplement according to any one of claims 1 to 12 to human milk or infant formula to form a fortified human milk or fortified infant formula followed by administration of the fortified human milk or fortified infant formula to an infant.

15. The method according to claim 14 wherein the infant is a preterm infant.

16. The sterilized liquid protein supplement according to claim 1, wherein the supplement is clear or substantially clear.

17. The sterilized liquid protein supplement according to claim 11, wherein the sterilized liquid protein supplement is substantially free of fat and carbohydrate.
